(19) United States
(12) Patent Application Publication
(10) Pub. No.: US 2011/0308653 A1
(43) Pub. Date: Dec. 22, 2011

(54) DAMPER FOR USE IN A FLUID DELIVERY SYSTEM

(76) Inventors: Michael J. Zdroik, Metamora, MI (US); Robert J. Doherty, Syracuse, IN (US); Jackson Zel Roe, Goshen, IN (US)

(21) Appl. No.: 13/101,738

(22) Filed: May 5, 2011

Related U.S. Application Data
(63) Continuation-in-part of application No. 13/090,840, filed on Apr. 20, 2011, now abandoned.
(60) Provisional application No. 61/356,334, filed on Jun. 18, 2010.

(51) Int. Cl. F16L 55/04

(52) U.S. Cl. 138/30

(57) ABSTRACT

A fuel delivery system comprises a source, a fuel rail, and a damper coupled therebetween. The damper comprises a body having first and second sides, and a sidewall extending therebetween. The first and second sides and sidewall combine to define a cavity. The damper further includes first and second ports disposed in the sidewall of the body. A first portion of the first port is disposed outside of the cavity, and a second portion is disposed within the cavity. The second portion further includes an orifice therein to allow fluid to be communicated between the first port and the cavity. A first portion of the second port is disposed outside of the cavity of the body, and a second portion is disposed proximate the cavity. A portion of the first and/or second sides of the body has a diaphragm shape, thereby rendering the portion flexible.

### CROSS REFERENCE TO RELATED APPLICATIONS

This application claims the benefit of U.S. Provisional Application Ser. No. 61/356,334 entitled “Damper for Use in a Fuel Delivery System,” which was filed on Jun. 18, 2010, and which is hereby incorporated by reference in its entirety.

### FIELD OF THE INVENTION

The field of the present invention is fluid delivery systems. More particularly, the present invention relates to fluid delivery systems, such as, for example, fuel delivery systems for vehicular applications, as well as a damper for use with the same.

### BACKGROUND OF THE INVENTION

Fluid delivery systems may be used in a variety of applications wherein fluid must be delivered from one point to another. One exemplary fluid delivery system is a vehicular fuel delivery system used with, for example, fuel-injected engines of various types of on-road and off-road vehicles. Such fuel delivery systems typically include a fuel source and one or more fuel rails having a plurality of fuel injectors associated therewith. Fuel from the fuel source is communicated to the fuel rail via fuel lines coupled between the fuel source and the fuel rail.

One inherent problem with these types of fuel delivery systems is pressure pulsations generated within the system, such as, for example, by the engine/fuel rail or at the fuel source that can travel through the fuel delivery system. If left undampened, these pressure pulsations may adversely impact the performance of the fuel delivery system by, for example, generating noise that is undesirable for the occupants of the vehicle of which the fuel delivery system is a part. Accordingly, attempts have been made to dampen pressure pulsations in fuel delivery systems.

For example, one known system includes placing a pressure pulsation damper between the fuel source and fuel rail. In such an arrangement, the damper eliminates the direct coupling of the fuel source with the fuel rail, and serves to dampen pressure pulsations or waves traveling within the fuel delivery system. These dampers may take on the appearance of a hockey puck in that they comprise a body having a cylindrical shape, and also include a cavity in the body. These dampers further include an inlet port and an outlet port for coupling to other components of the fuel delivery system and to allow fuel to be communicated to and from the cavity of the body. In operation, fuel travels from the fuel source through a fuel line to the inlet of the damper and then into the cavity of the body. The fuel in the cavity then travels from the cavity, through the outlet of the damper to a fuel line connected thereto, and on to the fuel rail. The damper body serves to dampen the pressure pulsations traveling through the fuel lines.

Such dampers are not without their disadvantages, however. For example, these types of damper bodies have two flat sides (e.g., top and bottom) and a sidewall disposed between and perpendicularly to the two flat sides. The edges or corners at the transition between the two flat sides and the sidewall are substantially squared-off at approximately 90 degrees. Such a construction results in high stress being applied at the edges or corners, and thus, there is an elevated risk of fatigue failures. Additionally, while these types of dampers with two flat sides reduce pressure pulsations, there is room for improved dampening to eliminate, or at least substantially reduce, the pressure pulsations that make it past the damper.

Therefore, there is a need for a fluid delivery system, and a damper therefor, that will minimize and/or eliminate one or more of the above-identified deficiencies.

### SUMMARY OF THE INVENTION

The present invention is directed to a fluid delivery system. In an exemplary embodiment the fluid delivery system is a fuel delivery system. The fuel delivery system comprises a fuel source, a fuel rail, and a damper coupled to and between the fuel source and the fuel rail. The damper comprises a body. The body includes a first side disposed in a first plane, a second side disposed in a second plane parallel to the first plane, and a sidewall extending between the first and second sides and perpendicular to the first and second planes. The first side, second side, and sidewall define a cavity of the body of the damper.

The damper body further includes a first port comprising a first tube disposed in the sidewall, and a second port comprising a second tube also disposed in the sidewall. The first tube of the first port comprises a first end and a second end with a fluid passageway extending therebetween. The first end of the first tube comprises an open end and the second end comprises a closed end. Further, a first portion of the first tube, including the first end, is disposed outside of the cavity, and a second portion of the first tube, including the second end, is disposed within the cavity. The second portion of the first tube further includes an orifice therein so as to allow fluid (e.g., fuel) to be communicated between the first tube and the cavity.

In an exemplary embodiment, the second tube of the second port also comprises a first end and a second end with a fluid passageway extending therebetween. The first end comprises an open end disposed outside of the cavity of the damper body, and the second end comprises an open end disposed proximate the cavity.

Additionally, in an exemplary embodiment, a portion of at least one of the first and second sides of the body has a diaphragm shape, thereby rendering the portion(s) of the first and/or second sides flexible.

Further features and advantages of the present invention, including the constituent components thereof, will become more apparent to those skilled in the art after a review of the invention as it is shown in the accompanying drawings and detailed description.

### BRIEF DESCRIPTION OF THE DRAWINGS

FIG. 1 is a diagrammatic and schematic view of an exemplary embodiment of a fluid delivery system in accordance with the present teachings.

FIG. 2 is a perspective view of an exemplary embodiment of a damper for use in connection with a fluid delivery system, such as, for example, the fluid delivery system of FIG. 1, in accordance with the present teachings.

FIG. 3 is a side view of the damper illustrated in FIG. 2.

FIG. 4 is a cross section view of the damper illustrated in FIGS. 2 and 3 taken along the lines 4-4 in FIG. 3.

FIG. 5 is an exploded perspective view of the damper illustrated in FIGS. 2 and 3.

FIG. 6 is a cross section view of the damper illustrated in FIGS. 2 and 3 taken along the lines 6-6 in FIG. 2.

FIG. 7 is a cross section view of an alternate embodiment of the damper illustrated in FIGS. 2, 3, and 6.

### DETAILED DESCRIPTION OF PREFERRED EMBODIMENTS

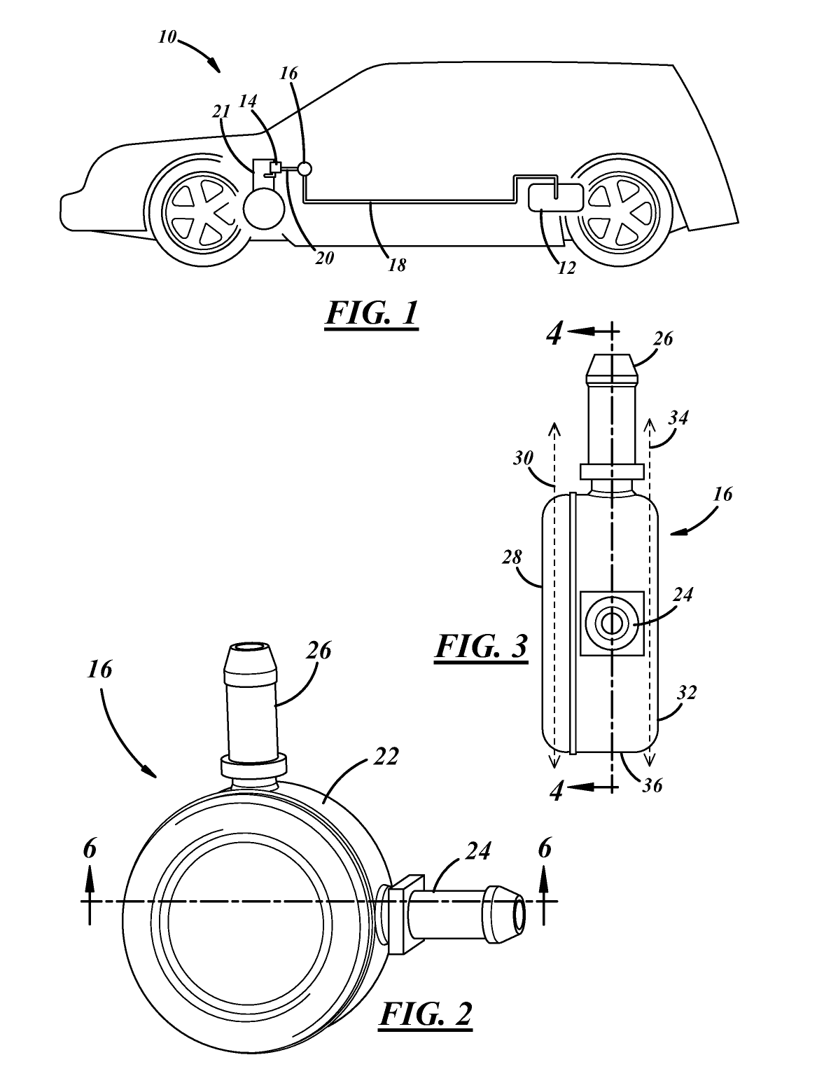

Referring now to the drawings wherein like reference numerals are used to identify identical components in the various views, FIG. 1 illustrates one exemplary embodiment of a fluid delivery system 10, which, in an exemplary embodiment, comprises a fuel delivery system. For purposes of clarity and ease of description, the description below will be limited to a fluid delivery system comprising a fuel delivery system for a vehicular application and the constituent components thereof. It will be appreciated by those having ordinary skill in the art, however, that the description below finds applicability in fluid delivery systems other than fuel delivery systems or vehicular fuel delivery systems. Therefore, types of fluid delivery systems other than fuel delivery systems or vehicular fuel delivery systems remain within the spirit and scope of the present invention.

With continued reference to FIG. 1, in an exemplary embodiment, the fuel delivery system 10 comprises a fuel source 12, a fuel rail 14, and a damper 16 coupled to and between the fuel source 12 and the fuel rail 14. As will be described in greater detail below, in an exemplary embodiment, the fuel source 12, which may comprise a fuel tank of a vehicle and/or a fuel pump associated therewith, is coupled to the damper 16 by way of a fuel line 18 (also referred to as a chassis line). Similarly, in an exemplary embodiment, the fuel rail 14, which has one or more fuel injectors associated therewith, is coupled to the damper 16 by way of a fuel line 20. Accordingly, fuel flows from the fuel source 12, through the fuel line 18, through the damper 16, through the fuel line 20, to the fuel rail 14, and then onto the engine 21 of the vehicle through the fuel injectors associated with the fuel rail 14.

With reference to FIGS. 2-6, the damper 16 of the fuel delivery system 10 will now be described. The damper 16 is operative to serve as a pulse damper to reduce pressure pulsations in the chassis or fuel lines (e.g., fuel lines 18, 20) of the fuel delivery system. Accordingly, the damper 16 is disposed in-line within the fuel line connecting the fuel source 12 and the fuel rail 14 to decouple the fuel source 12 from the fuel rail 14, and therefore, the fuel source 12 from the engine 21 of the vehicle. As illustrated in FIG. 2, the damper 16 comprises a body 22, a first port 24, and a second port 26. In one exemplary embodiment, the first port 24 comprises an inlet port of the damper 16, while the second port 26 comprises an outlet port of the damper 16. Alternatively, in another exemplary embodiment, the first port 24 comprises an outlet port of the damper 16, while the second port 26 comprises an inlet port of the damper 16.

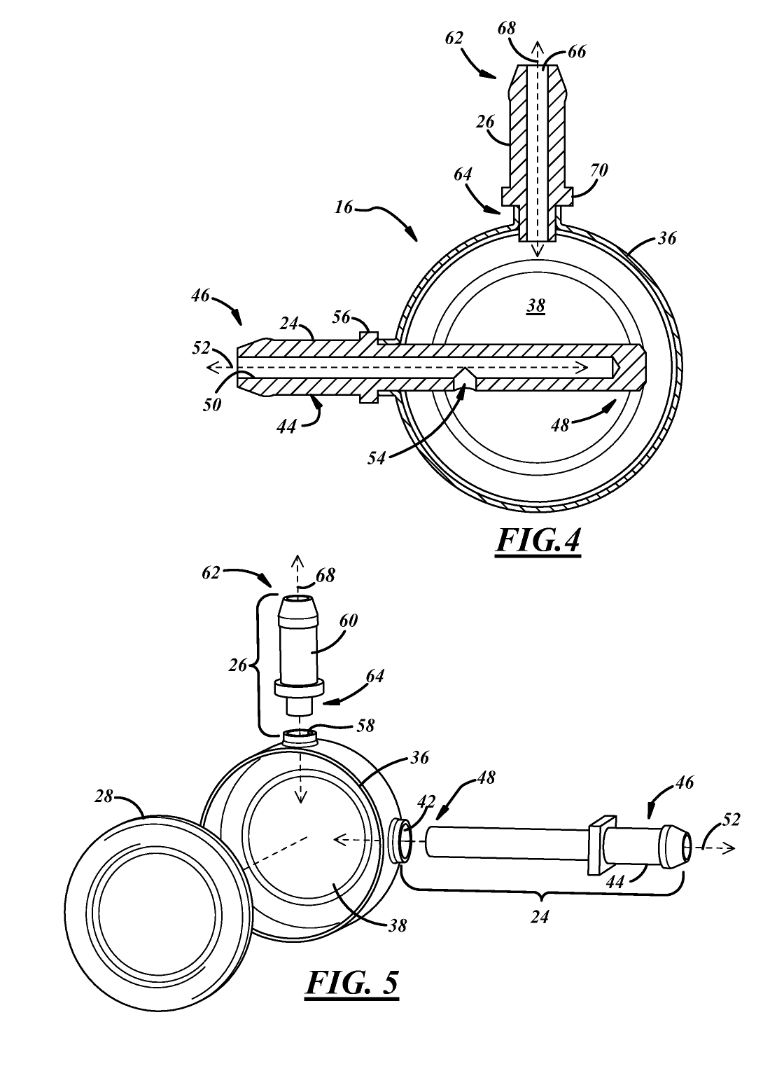

With reference to FIG. 3, the body 22 of the damper 16 comprises a first side 28 disposed in a first plane 30, a second side 32 disposed in a second plane 34 that is parallel to the first plane 30, and a sidewall 36 extending between the first and second sides 28, 32 and perpendicular to both first plane 30 and second plane 34. The first side 28, second side 32, and sidewall 36 combine to form a cavity 38 of the body 22 (best shown in FIGS. 4 and 5). As shown in FIGS. 2, 4, and 5, in an exemplary embodiment, the body has a substantially cylindrical shape (e.g., shaped like a hockey puck), and therefore, the first and second sides 28, 32 have a circular shape, while the sidewall 36 comprises a circumferential sidewall. It will be appreciated by those having ordinary skill in the art, however, that damper bodies having shapes other than a cylindrical shape remain within the spirit and scope of the present invention.

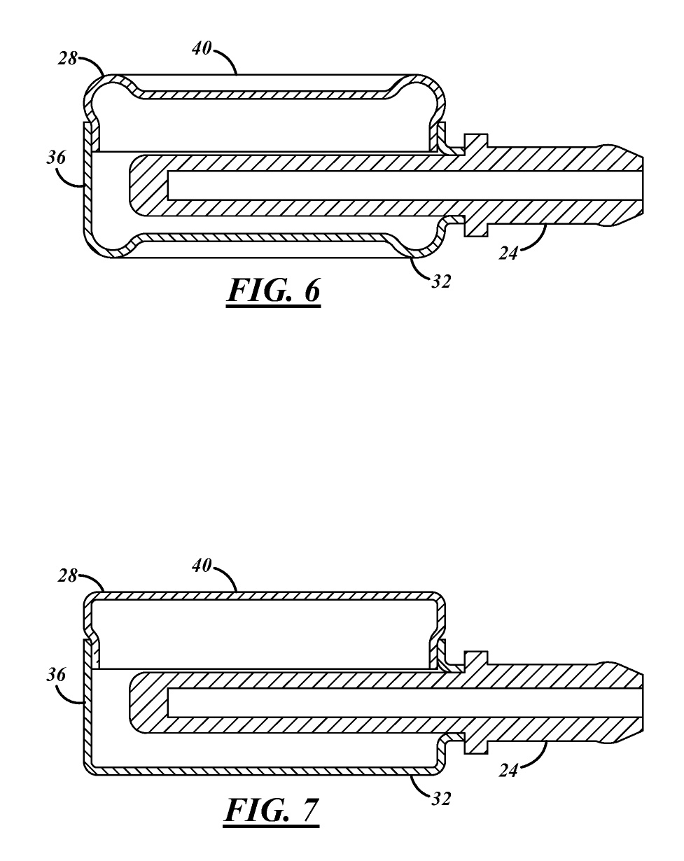

In an exemplary embodiment, the body 22, and the first side 28, second side 32, and sidewall 36 thereof in particular, is formed of stainless steel. It will be appreciated by those having ordinary skill in the art, however, that in other exemplary embodiments, materials other than stainless steel may be used to construct the body 22. Additionally, the body 22 may have a unitary construction or may be constructed of two or more pieces that are affixed together using techniques well known in the art, such as, for example, brazing, welding, laser welding, plasma welding, and friction welding processes. For example, and as illustrated in FIGS. 5 and 6, in one exemplary embodiment, the body 22 is formed of two stamped pieces that, when assembled and affixed together, results in the body 22 having the first and second sides 28, 32 being disposed in parallel planes 30, 34, with the sidewall 36 extending between the first and second sides 28, 32 and perpendicular to the planes 30, 34.

In addition to the above, in an exemplary embodiment illustrated, for example, in FIG. 6, one or both of the first and second sides 28, 32 have a radiused edge, as opposed to squared-off or angled edges. Additionally, as illustrated in FIG. 6, in an exemplary embodiment, one or both of first and second sides 28, 32 are constructed to have a diaphragm shape. More particularly, a portion of one or both of the first and second sides 28, 32 are shaped as a convoluted diaphragm (i.e., the shape mimics that of a traditional convoluted rubber diaphragm). For example, in FIG. 6, a portion 40 of the first side 28 of the body 22 has a diaphragm shape. Conventional dampers typically have flat sides that result in high stress at the edges or corners of the damper body. The geometry described above (e.g., radiused edges and/or diaphragm-shaped side(s)) causes the diaphragm-shaped side(s) of the body 22 to be flexible and to deflect upon forces applied thereto by the pressure in the cavity 38 exceeding the resiliency force of the diaphragm-shaped side(s). As a result, stress is reduced and the risk of failure due to fatigue is substantially reduced. However, it will be appreciated that in other exemplary embodiments, the first and second sides 28, 32 may not have a diaphragm shape and/or radiused edge(s) (see, for example, FIG. 7), and those embodiments remain within the spirit and scope of the present invention.

As described above, in an exemplary embodiment, the body 22 is constructed of stainless steel. The thickness of the steel used for the various parts of the body 22—e.g., the first and second sides 28, 32 and/or the sidewall 36—is dictated by amount of pressure to which the body 22 will be exposed by the fuel being communicated. For example, in one embodiment provided for exemplary purposes only, the pressure is on the order of 300-600 kPa. At this pressure, the thickness of the diaphragm-shaped side(s) would be approximately 0.6-1.1 mm. Additionally, the first and second sides 28, 32 and the sidewall 36 may have the same wall thickness or, in an exemplary embodiment, the different components of the body may have differing thicknesses. For example, in an exemplary embodiment wherein the body 22 comprises two pieces that are affixed or coupled together, one piece (e.g., the top piece) may have a thickness of approximately 0.76 mm, while the second piece (e.g., the bottom piece) may have a thickness of approximately 1.1 mm. Accordingly, damper bodies having a constant thickness throughout or having different portions with different thicknesses are both within the spirit and scope of the present invention. Additionally, the specific thicknesses above are provided for exemplary purposes only and are not meant to be limiting in nature. Accordingly, damper bodies and components thereof having thicknesses less than or greater than those thicknesses set forth above remain within the spirit and scope of the present invention.

It will be appreciated, however, that the sides 28, 32 and sidewall 36 may be constructed to have a thickness that is less than or greater than the aforementioned range, and such constructions remain within the spirit and scope of the present invention.

With reference to FIGS. 4 and 5, the first port 24 of the damper 16 will now be described. As briefly described above, the first port 24 may comprise either an inlet port or an outlet port. In an embodiment wherein the first port 24 comprises an inlet port, the first port 24 is configured to be coupled with the fuel source 12 through, for example, the fuel line 18. Alternatively, in an embodiment wherein the first port 24 comprises an outlet port, the first port 24 is configured to be coupled with the fuel rail 14 through, for example, the fuel line 20. Whether the first port 24 comprises an inlet port or an outlet port, it may take on a number of constructions or configurations.

For example, in an exemplary embodiment, the first port 24 comprises an aperture 42 (best shown in FIG. 5) in the sidewall 36. In another exemplary embodiment, the first port 24 comprises the combination of the aperture 42 and a tube 44. In such an embodiment, a portion of the tube 44 is disposed within the aperture 42 and affixed or coupled to the damper body 22 (e.g., the sidewall 36) using techniques that are well known in the art such as, for example, brazing, welding, laser welding, plasma welding, friction welding, and other like coupling processes or techniques. In another exemplary embodiment, the first port 24 may comprises the tube 44 wherein the tube 44 is integrally formed with the sidewall 36 of the body 22 (i.e., unitary construction), and therefore, does not also include the aperture 42. In any of the aforementioned embodiments, the first port 24 is configured to allow fuel to flow either into the cavity 38 of the body 22 from the fuel source 12 (when the first port 24 is an inlet port), or from the cavity 38 to the fuel rail 14 (when the first port is an outlet port).

In either embodiment described above wherein the first port 24 comprises, at least in part, the tube 44, in an exemplary embodiment the tube 44 is constructed of stainless steel. It will be appreciated by those having ordinary skill in the art, however, that other materials may be used in the construction of the tube 44, and therefore, tubes constructed of materials other than stainless steel remain within the spirit and scope of the present invention. The tube 44 includes a first end 46, a second end 48, and a fluid passageway 50 disposed therein and extending between the first and second ends 46, 48. The fluid passageway 50 defines a central axis 52 of the tube 44 and is configured to allow fuel to flow into or from the cavity 38, depending on whether the first port 24 is an inlet or outlet port. In one embodiment provided for exemplary purposes only, the fluid passageway 50 has a diameter in the range of approximately 5.0-9.5 mm. It will be appreciated, however, that passageways having diameters less than or greater than this exemplary range remain within the spirit and scope of the present invention.

With reference to FIG. 4, the first end 46 of the tube 44 is an open end and the second end 48 is a closed end. A first portion of the tube 44, including the first end 46, is disposed outside of the cavity 38 of the body 22. The first end 46 is configured to be coupled with one of the fuel lines 18, 20, depending on whether the first port 24 is an inlet or an outlet port. In either instance, the first end 46 may be coupled with the respective fuel line 18, 20 in a number of ways known in the art. For example, a quick-connect connection arrangement may be used, the fuel line may be crimped onto the first end 46 of the tube 44 (i.e., the first end 46 may include barbs thereon configured to penetrate the inner surface of the fuel line, for example), hose clamps may be used, or any other coupling technique known in the art.

Conversely, a second portion of the tube 44, including the second end 48 extends into and is disposed within the cavity 38 of the body 22. As described above, the second end 48 of the tube 44 is a closed end. The closed end of the tube 44 acts as a reflective end of the tube 44 and is operative to cause pressure pulsations or waves generated by either the fuel source 12 or the engine 21/fuel rail 14 traveling within the respective fuel lines 18, 20 (depending on whether the first port 24 is an inlet or outlet port) to reflect back to the source of the pressure waves so as to create a frequency shift, as opposed to allowing the pressure waves to travel further down the fuel line 18, 20 to the fuel source 12 or the engine/fuel rail 14, respectively.

The tube 44, and the second portion thereof in particular, further includes an orifice 54 therein. The orifice 54 is configured to allow restrictive or non-restrictive flow of fuel either from the fluid passageway 50 of the tube 44 into the cavity 38 (when the first port 24 is an inlet port), or from the cavity 38 into the fluid passageway 50 (when the first port 24 is an outlet port). In one embodiment provided for exemplary purposes only, the orifice 54 has a diameter in the range of approximately 2.3-6.4 mm. It will be appreciated, however, that orifices having diameters less than or greater than this exemplary range remain within the spirit and scope of the present invention. Further, in an exemplary embodiment illustrated, for example, in FIG. 4, the tube 44 is oriented within the cavity 38 in such a way that the orifice 54 faces away from the second port 26 of the damper 16. More particularly, in the illustrated embodiment, the orifice 54 faces a portion of the sidewall 36 that is on the opposite side of the damper body 22 from the second port 26. Accordingly, the tube 44 is oriented in such a way so as to prevent the direct communication of fuel between the orifice 54 and the second port 26.

The construction of the tube 44 and the orifice 54 thereof, as well as the arrangement of the tube 44 within the cavity 38, may serve to tune the damper 16. More specifically, characteristics of the tube 44 such as, for example, the overall length of the tube, the length of the portion of the tube that is disposed within the cavity 38 (i.e., the distance the tube 44 extends into the cavity 38), the diameter of the tube 44, and the size and shape of the orifice 54 (i.e., the diameter and the shape—e.g., circular, oval, oblong, etc.), as well as the positioning of the closed end 48 of the tube 44 within the cavity and the orientation of the orifice 54 relative to the second port 26, all may have an impact on the tuning of the damper 16.

In addition to the above, in an embodiment wherein the first port 24 comprises the tube 44 disposed within the aperture 42, the tube 44 may further include a locating feature so as to allow for the tube 44 to be properly inserted into the aperture 42. More particularly, the locating feature ensures that the second portion of the tube 44 is inserted the appropriate distance into the aperture 42, and therefore, cavity 38. As illustrated in FIG. 4, in an exemplary embodiment, the locating feature comprises a shoulder 56 on the tube 44 that limits the insertion of the tube 44 into the aperture 42, and therefore, allows for the tube 44, and the second portion thereof in particular, to be properly located. Accordingly, when the damper 16 is assembled, the second end 48 of the tube 44 is inserted into the aperture 42 (thus, the outer diameter of the second end 48 of the tube 44 is smaller than the inner diameter of the aperture 42) until the shoulder 56 contacts the sidewall 36. The tube 44 may also be rotated so as to properly orient the orifice 54 within the cavity. Once the tube 44 is properly inserted and the orifice is suitably oriented, the tube 44 may be affixed or coupled to the sidewall as described above. Accordingly, the shoulder 56 may also comprise a coupling or affixation surface that abuts the sidewall 36 when the tube 44 is properly inserted into the aperture 42, and is configured to be affixed thereto.

With reference to FIGS. 4 and 5, the second port 26 of the damper 16 will now be described. As briefly described above, the second port 26 may comprise either an inlet port or an outlet port (i.e., if the first port 24 comprises an inlet port, the second port 26 comprises an outlet port, and vice versa). In an embodiment wherein the second port 26 comprises an inlet port, the second port 26 is configured to be coupled with the fuel source 12 through, for example, the fuel line 18. Alternatively, in an embodiment wherein the second port 26 comprises an outlet port, the second port 26 is configured to be coupled with the fuel rail 14 through, for example, the fuel line 20. Whether the second port 26 comprises an inlet port or an outlet port, it may take on a number of constructions or configurations.

For example, in an exemplary embodiment, the second port 26 comprises an aperture 58 (best shown in FIG. 5) in the sidewall 36. In another exemplary embodiment, the second port 26 comprises the combination of the aperture 58 and a tube 60. In such an embodiment, a portion of the tube 60 is disposed within the aperture 58 and affixed or coupled to the damper body 22 (e.g., the sidewall 36) using techniques that are well known in the art such as, for example, brazing, welding, laser welding, plasma welding, friction welding, and other like coupling processes or techniques. In another exemplary embodiment, the second port 26 may comprises the tube 60 wherein the tube 60 is integrally formed with the sidewall 36 of the body 22 (i.e., unitary construction), and therefore, does not also include the aperture 58. In any of the aforementioned embodiments, the second port 26 is configured to allow fuel to flow either into the cavity 38 of the body 22 from the fuel source 12 (when the second port 26 is an inlet port), or from the cavity 38 to the fuel rail 14 (when the second port is an outlet port).

In either embodiment described above wherein the second port 26 comprises, at least in part, the tube 60, in an exemplary embodiment the tube 60 is constructed of stainless steel. It will be appreciated by those having ordinary skill in the art, however, that other materials may be used in the construction of the tube 60, and therefore, tubes constructed of materials other than stainless steel remain within the spirit and scope of the present invention. The tube 60 includes a first end 62, a second end 64, and a fluid passageway 66 disposed therein and extending between the first and second ends 62, 64. The fluid passageway 66 defines a central axis 68 of the tube 60 and is configured to allow fuel to flow into or from the cavity 38, depending on whether the second port 26 is an inlet or outlet port. In one embodiment provided for exemplary purposes only, the fluid passageway 66 has a diameter in the range of approximately 5.0-9.5 mm. It will be appreciated, however, that passageways having diameters less than or greater than this exemplary range remain within the spirit and scope of the present invention.

With continued reference to FIG. 4, the first and second ends 62, 64 of the tube 60 comprise open ends. A first portion of the tube 60, including the first end 62, is disposed outside of the cavity 38 of the body 22. The first end 62 is configured to be coupled with one of the fuel lines 18, 20, depending on whether the second port 26 is an inlet or an outlet port. In either instance, the first end 62 may be coupled with the respective fuel line 18, 20 in a number of ways known in the art. For example, a quick-connect connection arrangement may be used, the fuel line may be crimped onto the first end 62 of the tube 60 (i.e., the first end 62 may include barbs thereon configured to penetrate the inner surface of the fuel line, for example), hose clamps may be used, or any other coupling technique known in the art. Conversely, a second portion of the tube 60 including the second end 64 is disposed within the aperture 58, and at least proximate the cavity 38 of the body 22 (i.e., the end may extend into the cavity or rather may be disposed within the aperture and adjacent to the cavity) so as to allow fuel to be communicated either from the cavity 38 to the tube 60 and on to the fuel line 20, or into the cavity 38 from the fuel line 18, depending on whether the second port 26 is an inlet or outlet port.

Additionally, in an embodiment wherein the second port 26 comprises the tube 60 disposed within the aperture 58, the tube 60 may further include a locating feature so as to allow for the tube 60 to be properly inserted into the aperture 58. More particularly, the locating feature ensures that the second portion of the tube 60 is inserted the appropriate amount into the aperture 58, and possibly the cavity 38. As illustrated in FIG. 4, in an exemplary embodiment the locating feature comprises a shoulder 70 on the tube 60 that limits the insertion of the tube 60 into the aperture 58, and therefore, allows for the tube 60, and the second portion thereof, in particular, to be properly located. Accordingly, when the damper 16 is assembled, the second end 64 of the tube 60 is inserted into the aperture 58 (thus, the outer diameter of the second end 64 of the tube 60 is smaller than the inner diameter of the aperture 58) until the shoulder 70 contacts the sidewall 36. Once the tube 60 is properly inserted, the tube 60 may be affixed or coupled to the sidewall as described above. Accordingly, the shoulder 70 may also comprise a coupling or affixation surface that abuts the sidewall 36 when the tube 60 is properly inserted into the aperture 58, and is configured to be affixed thereto.

With reference to FIGS. 2-5, in exemplary embodiment the first and second ports 24, 26 are spaced apart from each other about the sidewall 36. In the embodiment illustrated in FIGS. 2-5, the respective central axes 52, 68 of the tubes 44, 60 are disposed in a perpendicular arrangement. It will be appreciated, however, that the first and second ports may be arranged in other spaced configurations and still remain within the spirit and scope of the present invention.

Although only certain embodiments of this invention have been described above with a certain degree of particularity, those skilled in the art could make numerous alterations to the disclosed embodiments without departing from the scope of this disclosure. Joinder references (e.g., attached, coupled, connected, affixed, and the like) are to be construed broadly and may include intermediate members between a connection of elements and relative movement between elements. As such, joinder references do not necessarily infer that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

1. A damper for use in a fluid delivery system, comprising:
a body, said body including:
a first side disposed in a first plane;
a second side disposed in a second plane parallel to said first plane; and
a sidewall extending between said first and second sides and perpendicular to said first and second planes;
wherein said first side, second side, and sidewall define a cavity of said body;
an inlet port disposed in said sidewall, said inlet configured to permit fluid to be communicated to said cavity; and
an outlet port disposed in said sidewall, said outlet configured to permit fluid to be communicated from said cavity;
wherein a portion of one of said first and second sides of said body has a diaphragm shape, thereby rendering said portion flexible.

2. The damper of claim 1, wherein a portion of the other of said first and said second sides of said body has a diaphragm shape thereby rendering said portion of said second side flexible.

3. The damper of claim 1, wherein one of said first and second sides of said body has a radiused edge.

4. The damper of claim 1, wherein said inlet port comprises a first aperture in said sidewall and said outlet port comprises a second aperture in said sidewall.

5. The damper of claim 1, wherein said inlet port comprises a tube having a fluid passageway therein, and further wherein said tube is integrally formed with said sidewall.

6. The damper of claim 1, wherein said inlet port comprises a tube having a fluid passageway therein, and further wherein:
said sidewall includes an aperture therein;
a portion of said tube is disposed within said aperture in said sidewall; and
said tube is coupled with said sidewall.

7. The damper of claim 1, wherein:
said inlet port comprises a tube having a fluid passageway therein; and
said tube comprises a first end and a second end with said fluid passageway extending therebetween, said first end comprising an open end and said second end comprising a closed end, and further wherein:
a first portion of said tube including said first end is disposed outside of said cavity; and
a second portion of said tube including said second end is disposed within said cavity, said second portion of said tube further including an orifice therein so as to allow fluid to be communicated between said tube and said cavity.

8. The damper of claim 7, wherein said orifice faces away from said outlet port in said body.

9. The damper of claim 1, wherein:
said inlet port comprises a tube having a fluid passageway therein; and
said tube comprises a first end and a second end with said fluid passageway extending therebetween, said first end comprising an open end disposed outside of said cavity of said body, and said second end comprising an open end disposed proximate said cavity.

10. The damper of claim 1, wherein said outlet comprises a tube having a fluid passageway therein, and further wherein said tube is integrally formed with said sidewall.

11. The damper of claim 1, wherein said outlet port comprises a tube having a fluid passageway therein, and further wherein:
said sidewall includes an aperture therein;
a portion of said tube is disposed within said aperture; and
said tube is coupled with said sidewall.

12. The damper of claim 1, wherein:
said outlet port comprises a tube having a fluid passageway therein; and
said tube comprises a first end and a second end with said fluid passageway extending therebetween, said first end comprising an open end and said second end comprising a closed end, and further wherein:
a first portion of said tube including said first end is disposed outside of said cavity; and
a second portion of said tube including said second end is disposed within said cavity, said second portion of said tube further including an orifice therein so as to allow fluid to be communicated between said tube and said cavity.

13. The damper of claim 12, wherein said orifice faces away from said inlet port in said body.

14. The damper of claim 1, wherein:
said outlet port comprises a tube having a fluid passageway therein; and
said tube comprises a first end and a second end with said fluid passageway extending therebetween, said first end comprising an open end disposed outside of said cavity of said body, and said second end comprising an open end disposed proximate said cavity.

15. A damper for use in a fluid delivery system, comprising:
a body, said body including:
a first side disposed in a first plane;
a second side disposed in a second plane parallel to said first plane; and
a sidewall extending between said first and second sides and perpendicular to said first and second planes;
wherein said first side, second side, and sidewall define a cavity of said body;
a first port comprising a first tube disposed in said sidewall, wherein
said first tube of said first port comprises a first end and a second end with a fluid passageway extending therebetween, said first end comprising an open end and said second end comprising a closed end, and further wherein
a first portion of said first tube including said first end is disposed outside of said cavity, and
a second portion of said first tube including said second end is disposed within said cavity, said second portion further including an orifice therein so as to allow fluid to be communicated between said first tube and said cavity; and
a second port comprising a second tube disposed in said sidewall.

16. The damper of claim 15, wherein said second tube of said second port comprises a first end and a second end with a fluid passageway extending therebetween, said first end comprising an open end disposed outside of said cavity of said body, and said second end comprising an open end disposed proximate said cavity.

17. The damper of claim 15, wherein a portion of one of said first and second sides of said body has a diaphragm shape, thereby rendering said portion flexible.

18. The damper of claim 15, wherein said orifice faces away from said second port.

19. The damper of claim 15, wherein a portion of the other of said first and second sides of said body has a diaphragm shape, thereby rendering said portion flexible.

20. The damper of claim 15, wherein one of said first and second sides of said body has a radiused edge.

21. A fuel delivery system, comprising:
a fuel source;
a fuel rail; and
a damper coupled to and between said fuel source and said fuel rail, said damper comprising:
a body, said body including:
a first side disposed in a first plane;
a second side disposed in a second plane parallel to said first plane; and
a sidewall extending between said first and second sides and perpendicular to said first and second planes;
wherein said first side, second side, and sidewall define a cavity of said body;
a first port comprising a first tube disposed in said sidewall, wherein:
said first tube of said first port comprises a first end and a second end with a fluid passageway extending therebetween, said first end comprising an open end and said second end comprising a closed end, and further wherein:
a first portion of said first tube including said first end is disposed outside of said cavity; and
a second portion of said first tube including said second end is disposed within said cavity, said second portion further including an orifice therein so as to allow fluid to be communicated between said first tube and said cavity; and
a second port comprising a second tube disposed in said sidewall.

22. The fuel delivery system of claim 21, wherein said second tube of said second port comprises a first end and a second end with a fluid passageway extending therebetween, said first end comprising an open end disposed outside of said cavity of said body, and said second end comprising an open end disposed proximate said cavity.

23. The fuel delivery system of claim 21, wherein a portion of one of said first and second sides of said body has a diaphragm shape, thereby rendering said portion flexible.

24. The fuel delivery system of claim 21, wherein said orifice faces away from said second port.

25. The fuel delivery system of claim 21, wherein a portion of the other of said first and second sides of said body has a diaphragm shape, thereby rendering said portion flexible.

26. The fuel delivery portion of claim 21, wherein one of said first and second sides of said body has a radiused edge.
